(19) United States
(12) Patent Application Publication
(10) Pub. No.: US 2016/0311423 A1
(43) Pub. Date: Oct. 27, 2016

(54) Vehicle resource management system

(71) Applicant: Contour Hardening, Inc., Indianapolis, IN (US)

(72) Inventor: John M. Storm, Danville, IN (US)

(21) Appl. No.: 15/184,333

(22) Filed: Jun. 16, 2016

Related U.S. Application Data
(63) Continuation of application No. PCT/US2014/069264, filed on Dec. 9, 2014.
(60) Provisional application No. 61/916,412, filed on Dec. 16, 2013.

(51) Int. Cl. B60W 20/12; B60L 11/18; B60W 30/16; B60L 7/08

(52) U.S. Cl. CPC B60W 20/12; B60L 7/08; B60L 11/1862; B60W 30/16; Y10S 903/947

(57) ABSTRACT

A vehicle resource management system for an electric vehicle includes programmable electronic controls integrated into the vehicle configured to consume resources during operation such as electricity, fossil fuels, and the like. Also included as part of the resource management system is an operational algorithm which communicates with the electronic controls to evaluate the driving range available for the available resources. The operational algorithm also receives and processes a plurality of trip variables, at least some of which may be entered by a user using a user interface.

### CROSS REFERENCE TO RELATED APPLICATION

This application is a continuation of PCT/US2014/069264 filed Dec. 9, 2014 which claims the benefit of U.S. Provisional Patent Application Ser. 61/916,412 filed Dec. 16, 2013, both of which are hereby incorporated by reference.

### BACKGROUND

The present invention as exemplified by this disclosure relates to the control and management of vehicle resources which restrict a vehicle's range. One concern with electrical vehicles is the state of charge of the battery relative to the trip which is contemplated. Depending on the trip variables of the specific route, including the distance, the issue or at least one issue, is whether the state of charge of the battery is sufficient to complete the trip and reach the intended destination. Another consideration is whether a charging station or charging capability will be present along the route and/or at the destination. The same types of issues arise with fossil fuel powered or hybrid vehicles with regard to the range of the vehicle and the relative location of refueling stations.

With regard to electric vehicles, this description is focused on, but not limited to, relatively shorter trips where a full battery charge would likely enable the electric vehicle to reach the intended destination. Something less than a full charge thus becomes problematic. If the existing charge is not sufficient for the electric vehicle to reach the intended destination, then an additional charge (i.e., recharge) would be required or it would be necessary to either alter the destination or alter the route or alter the manner of use of the vehicle or some combination of all of these. Shorter trips are less of a concern with fossil fuel powered vehicles or hybrid vehicles although these concerns are considered as well. One option for the electric vehicle is to detour from the intended route in order to reach a charging station or a charging vehicle. This alternative is intended to restore some or all of the charge on the battery, presumably to a level which is sufficient to allow the electric vehicle to get back on its intended route and reach the desired destination.

Although this description of what might occur is put into the context of a relatively shorter trip, such as to and from work, much longer trips would likely always require one or more stops at a charging station or a visit from a charging vehicle, based on the anticipated range for a fully charged electric vehicle. Nevertheless, even with such longer trips, there is value in being able to assess the remaining range for the vehicle in order to try and limit the number of recharging stops which have to be made during this longer trip in order to reach the destination. The “destination” could include a charging station, a charging vehicle, or a fossil fuel dispensing station.

Accepting that it would be beneficial to the use of a vehicle to know, or at least be able to predict with some likelihood of success, the remaining driving distance or range based on the state of charge or remaining fuel, one question is how to make this driving range determination. A related question is how to make the prediction or determination more accurate and reliable. With regard to electric vehicles, a related question is how one might vary or modify the manner of use of the electric vehicle to improve the likelihood of reaching the intended destination with the available charge on the battery. A number of variables can and will affect the driving range. These variables correspond to the vehicle specifics, the driving habits of the user, the specifics of the route selected and external conditions such as traffic and weather. One challenge is to try and identify all of the important variables which may affect driving range of the electric vehicle based on the state of charge any instant in time. Another challenge is assigning a “weight” to the most relevant variables, i.e., those with the greatest effect on the driving range of the electric vehicle.

The present invention, as exemplified by this disclosure, is directed to the design, development and application of a vehicle resource management system which is preferably used by an electric vehicle and by the operator of the electric vehicle as a way to help predict the probability of the vehicle reaching the intended destination given its current charge. The algorithm is based in part on current trip variables and changes to those variables as the trip proceeds. The algorithm is also based in part on historical variables as might be derived from a particular route which is repetitive. A wide variety of other information from other sources or resources is also contemplated for use in the algorithm.

Use of the disclosed algorithm, as integrated into the controls of the electric vehicle, provides a means for drivers of electric vehicles to have additional information regarding the projected driving range. This is the driving range remaining for the electric vehicle based on the state of charge on the vehicle battery (or batteries) at that instant in time. Obviously, this projected driving range may change either increasing or decreasing, as the trip continues, based on the changing variables. Other driving adjustments, control functions and control options are offered by the disclosed algorithm.

### SUMMARY

A resource management system for an electric vehicle includes programmable electronic controls integrated into the electric vehicle, the electric vehicle including a battery. Also included as part of the vehicle resource management system is an operational algorithm which communicates with the electronic controls to evaluate the driving range available for the existing charge on the battery. The operational algorithm receives and processes a plurality of trip variables. Included as well is a dynamic braking control algorithm to efficiently manage braking function.

Further forms, objects, features, aspects, benefits, advantages, and embodiments of the present invention will become apparent from a detailed description and drawings provided herewith.

### BRIEF DESCRIPTION OF THE DRAWINGS

FIG. 1 is a component diagram indicating vehicle features as well as subsystems included in the vehicle resource management system described and disclosed.

FIG. 2 is a schematic illustration of one example of system components and data flow which may be included in a vehicle controller shown in FIG. 1.

FIG. 3 is a flow chart describing further one example of actions taken by the vehicle controller from FIG. 2 in acquiring, processing, storing, and retrieving data to manage system resources.

FIG. 4 is a flow chart describing one example of the actions that may be taken by the vehicle controller in FIG. 2 to assess and apply vehicle braking.

FIG. 5 is a flow chart describing another example of actions that may be taken by the vehicle controller in FIG. 2 to assess and apply vehicle braking.

### DETAILED DESCRIPTION

For the purpose of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates. One embodiment of the invention is shown in great detail, although it will be apparent to those skilled in the relevant art that some features that are not relevant to the present invention may not be shown for the sake of clarity.

The following disclosure describes in detail various range prediction calculations and predictions based on various inputs specific to the current state and expected performance of an electric vehicle. However, as will be understood by one of ordinary skilled in the art, the procedures for predicting vehicle range for fossil fuel powered vehicle based on the principles discussed in the following detailed description are essentially the same. Although the description may at various points explicitly discuss electric vehicles, the use of fossil fuels in a hybrid vehicle or in a vehicle that uses only fossil fuels is also envisioned where applicable regardless of whether specific explicit mention is made of these other energy forms at each step of the disclosure. As used herein, the term “vehicle” is intended to be inclusive of all types of vehicles including autonomous, semi-autonomous and non-autonomous.

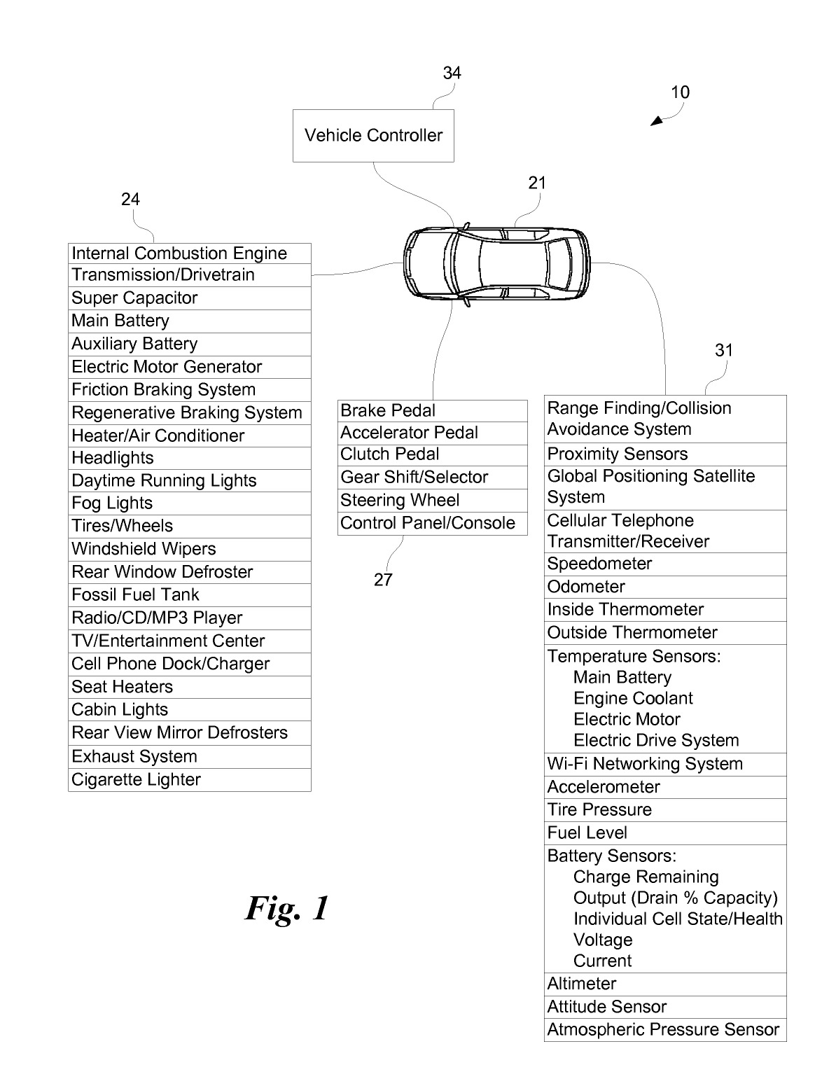

FIG. 1 illustrates at 10 an example of systems, devices, features, components, and various other aspects of a vehicle resource management system. These various features and aspects are included is a vehicle 21 operating as data inputs and outputs for the vehicle resource management system disclosed below. The inputs and outputs indicated are not exclusive given that vehicle technology is constantly evolving and changing. Therefore, other aspects and systems of vehicle 21 involving vehicle operations and resource consumption may be useful and are envisioned as well.

Vehicle 21 is shown with various aspects, features, and components separated into lists. Operational components 24 includes basic systems and aspects of vehicle 21 along with other features and components that provide functionality for the operator. Examples of operational components 24 are useful for vehicle operation and may exchange information with a vehicle controller 34 or with other systems included in the vehicle resource management system. These interactions may in turn cause vehicle controller 34 to send signals to one or more of the operational components 24 adjusting their behavior to achieve certain goals such as increased efficiency or various other operator preferred outcomes. These and other aspects are described in greater detail below.

Vehicle controls 27 includes examples of vehicle controls the vehicle operator may interact with to control vehicle 21. Other controls may be included or described in greater detail below. Data regarding the position and overall state of these controls may also be exchanged with vehicle controller 34 or with other components within the vehicle resource management system as described in greater detail below.

Communication and sensor devices 31 are also shown indicating some examples of various data collection devices, sensors, and systems. Communication and sensor devices 31 may communicate with outside systems by various means such as by sending or receiving radio transmissions from, for example, satellites, a cellular telephone network, and the like. Communication and sensor devices 31 may interact with operational components 24 to collect data such as fuel or battery charge remaining, tire pressures, power output of the internal combustion engine, and the like. This interaction may occur via wired or wireless connections between sensor devices 31, and one or more operational components 24. Communication and sensor devices 31 provide vehicle controller 34 and other aspects of the vehicle resource management system with data useful for making decisions as described in detail below.

Other aspects, features, components, sensors, and systems of vehicle 21 may also be used by various embodiments of the vehicle resource management system depending on the unique features of the particular vehicle and the particular activities it is engaged in. It should be noted that although vehicle 21 may appear as a mid-size car or sedan, no limitation on the make, model, size, or any other particular vehicle attribute should be implied by the drawing as the drawing is exemplary only rather than restrictive. For example, vehicle 21 may appear to be illustrated as having four doors and two headlights. However, vehicle 21 may be a motorcycle having no doors and only one headlight. Vehicle 21 may be a mini-van, light truck, school bus, multi-axle semi-tractor with or without a trailer, delivery van, compact car, motorcycle, or sports car to name a few non-limiting examples.

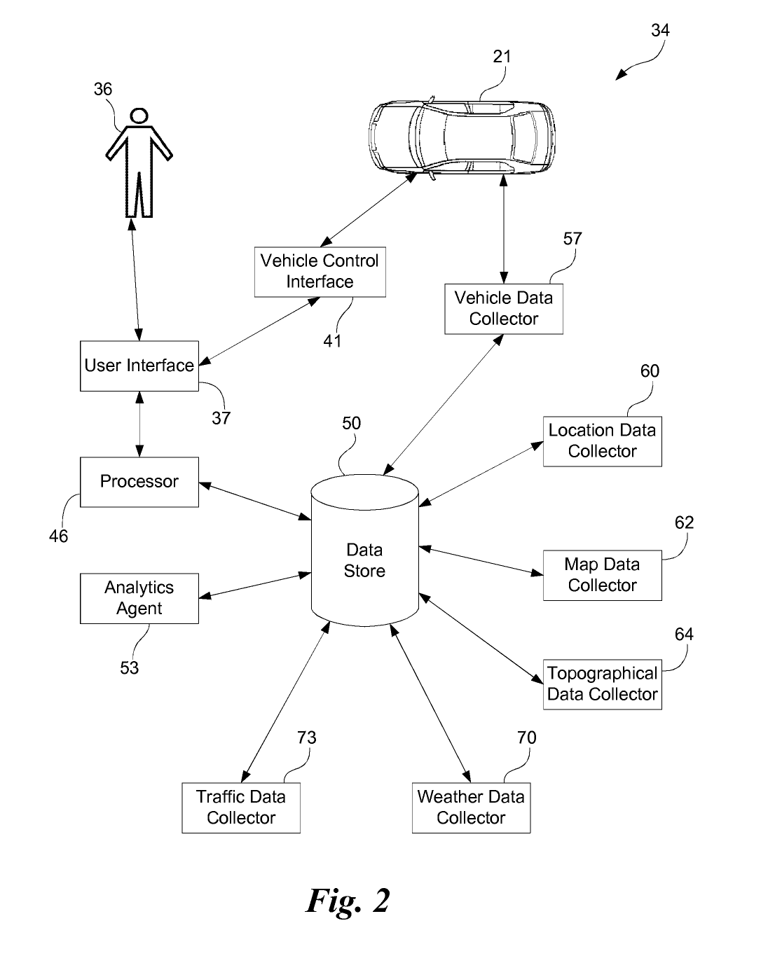

FIG. 2 illustrates in schematic form further detail of one example of components that may be included in a vehicle controller 34. A vehicle controller shown at 34 includes a user interface 37 for use by a user 36 such as a driver or other occupant of vehicle 21, a vehicle control interface 41 for interfacing with other vehicle systems, a data store 50, a processor 46, and an analytics agent 53. User interface 37 accepts user input from user 36 such as destinations and possibly other driver specific parameters affecting vehicle performance. User interface 37 can also be used by user 36 to signal processor 46 to calculate a range prediction based on resource availability and consumption, or optionally to request range predictions recur repeatedly at predetermined intervals until otherwise directed by the user or the system.

Processor 46 may make a range prediction by taking any of a variety of actions involving the current state of the vehicle and its location with respect to a selected destination. For example, a range prediction calculation may include reading data from data store 50, calculating the predicted probability of reaching a destination entered by user 36 using user interface 37, writing the results of the calculation back to data store 50, and updating the user interface 37. User interface 37 may then be configured to present the user with various energy consumption related options offering the user opportunities to input subsequent selections to refine the prediction, make a new prediction, or act on the current prediction. Where the user decides to act on the current prediction, vehicle controller 34 may then assemble a sequence of commands or signals for controlling the behavior of the vehicle which are readable by vehicle 21 and pass them to the various vehicle subsystems using vehicle control interface 41. Vehicle control interface 41 can interact with various systems in vehicle 21 to collect data about the vehicle, such as the data indicated in FIG. 1, or to pass commands to the systems in vehicle 21 modifying the behavior of the vehicle as determined by the algorithm.

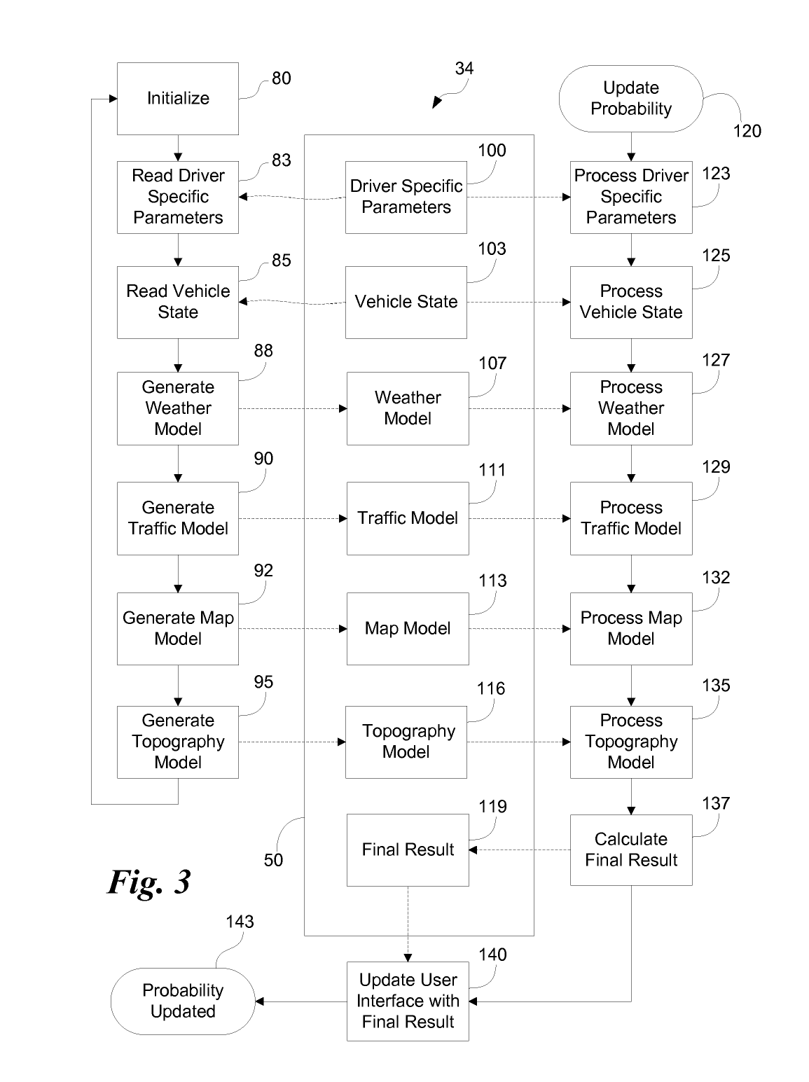

As illustrated in FIGS. 2 and 3, the algorithm operating in vehicle controller 34 can make predictions using data received from numerous sources, some examples of which are shown. For example, a vehicle data collector 57 collects information from the vehicle itself. On one hand, this information may include various information related to battery drain such as the present electrical current draw on the battery (measured in Amperes) and the potential difference across the battery terminals (measured in Volts). In some vehicles, the main battery may be composed of multiple individual cells coupled together in series or in parallel, or in a series/parallel arrangement, in which case the current and potential difference data collected by vehicle data collector 57 may include current and potential difference information for each cell, or for groups of cells within the main battery.

Resource consumption information may also include flags, signals, or other indicators indicating whether and to what extent particular subsystems or accessories are active such the windshield wipers, air conditioner or heater, head lights, day time running lamps, radio or entertainment center, cell phone, laptop computer, or other charger or docking station, cigarette lighter, electric rear window defrosters, electric rear view mirror defrosters, seat heaters, or proximity, range finding, or anti-collision sensors. Vehicle data collector 57 may also receive individual current and/or voltage data indicating drain on the battery or overall power consumption of each of these accessories or subsystems.

In the hybrid or fossil fuel context, vehicle data collector 57 may receive other information like type of fuel or fuel composition, quantity of fuel remaining, recent and/or current burn rate, and fuel mixture. Vehicle data collector 57 may also collect and process information about the density of air entering the engine, the composition of the fuel air mixture being burned, and the composition of resulting exhaust gases, any one of which alone, or used together in combination, may be helpful in calculating the probability of reaching a given destination following a particular route or set of routes.

As the trip progresses, changes may occur like new direct input from the user, changes in the environment, and the like. The user may, for example, activate or deactivate a system that substantially increases or decreases load on the battery or the current fuel burn rate such as a heater, air conditioner, head lights, or seat heaters. In another example, the user may increase or decrease the average rate of speed, or begin to drive more smoothly or more erratically resulting in a change in the extent and/or frequency of speed and direction changes. Vehicle data collector 57 may therefore be optimized to monitor vehicle status information and update data store 50 so as to provide processor 46 with information from which to make a trip prediction. In one example, vehicle data collector 57 can read or sample data values representing the state or recent behavior of various vehicle systems at a very high number of samples per second saving the collected data values to data store 50. For example, vehicle data collector may read and store some or all of the available vehicle data values more than several hundred, several thousand, or tens of thousands of times a second generating a large quantity of stored data for analysis. Another example of vehicle data collector 57 monitors vehicle 21 reading, sampling and storing vehicle data collecting more infrequent snapshots of all available vehicle data values at intervals greater than every hundredth of a second, greater than every second, greater than every 10 seconds, greater than every 30 seconds, or more.

It may, however, be cost prohibitive to implement a real-time, or near-real-time monitoring system collecting data from all the vehicle's systems at thousands or millions of times per second. Other examples of vehicle data collector 57 include an event based or interrupt driven data collector 57 which writes vehicle data to data store 50 when another data collector, a vehicle subsystem, or other device notifies the vehicle data collector 57 of an event that the vehicle data collector 57 is programmed or configured to respond to. For example, rather than constantly saving a data value corresponding to the current draw caused by the headlights a predetermined 10 times per second, vehicle data collector 57 may only read or sense and store these data values after it has received a signal from vehicle 21 indicating the headlights have been activated. Other similar events that may be monitored include, but are not limited to, activation of the vehicle's heater, rear window defroster, seat heaters, air conditioner, entertainment center, or any other events which may increase or decrease the rate at which available vehicle resources such as battery charge and fuel are being consumed. In another example, it may only be desirable to store time and interval data indicating which systems were active, for what interval of time, and the high, low, and average voltage, current, and power usage rather than storing individual values. These embodiments of vehicle data collector 57 can reduce the storage capacity required to maintain data store 50 but may also result in less accurate predictions because of a corresponding reduction in the available sample size of the collected data values. It may also be advantageous in some embodiments of data store 50, vehicle data collector 57, or both, to implement a data compression scheme for reducing the physical or virtual storage space required to maintain data store 50.

Geospatial positional information including latitude and longitude of the vehicle may be gathered by a location data collector 60 and written to data store 50. One example of location data collector 60 uses a Global Positioning Satellite (GPS) system which can operate together with a GPS enabled device coupled to location data collector 60 to provide updated location data. As with the vehicle data collector 57, location data collector 60 may be implemented to sample or read location data values at a slower rate that is greater than every second, or greater than every 10 seconds, or at a much faster rate generating a much higher quantity of data such as greater than a thousand times a second, or greater than ten thousand times a second to name just a few examples. Data compression may also be useful as well to keep the physical or logical size of the location data saved in data store 50 from becoming unmanageably large.

The GPS system including, antenna, radio transmitter, and or radio receiver may either be part of the original equipment integrated into vehicle 21 by the manufacturer or added separately at a later time. In another example, the GPS system and radio transmitter or receiver are integrated into a single unit such as a cell phone, smart phone, or portable computer which can be connected to location data collector 60 through a wired or wireless connection. Another example of location data collector 60 uses a radio transceiver to triangulate the position of vehicle 21 using radio signals such as from a cellular telephone network or similar source. These radio signals may be received and/or transmitted by a smart phone, cell phone, tablet computer, or similarly equipped cellular communication device capable of sending and/or receiving signals. For example, user 36 may dock or otherwise couple a smartphone to vehicle controller 34 and use the GPS features within the cell phone to obtain positional information to be used by the predictive algorithm.

Regardless of how the positional information is acquired, location data collector 60 acquires the positional data and writes the information to data store 50. Using this data, processor 46 can accurately model relationships between locations and resource consumption such as battery drain and fuel consumption. One embodiment of location data collector 60 writes a positional record whenever a positional fix is acquired saving the best-known latitude and longitude, along with a timestamp. This embodiment gives processor 46 accurate location data but may also result in a physical or logical size requirement for data store 50 that is prohibitively large and/or expensive. In another example, location data collector 60 acquires the position of vehicle 21 at regular intervals such as about every half second, every second, or every five seconds, or perhaps more often or less often. Location data collector 60 may write this data to data store 50 each time it is received, or write the data to data store 50 at a second separate predetermined interval, and then perhaps only if the positional data is above a particular quality threshold. Any device or system coupled to vehicle 21 that is capable of determining its location on the earth, or relative to other landmarks is envisioned.

Positional information, as well as other data useful for predicting resource consumption, may also be correlated to map data to further develop and refine the disclosed resource consumption calculations. Map data may be gathered by a map data collector 62 and written to data store 50 where it can be accessed by the processor 46 and other modules within vehicle controller 34. One example of map data collector 62 obtains map information from remote computer systems. These remote computer systems can include servers networked together using a computer network such as the internet which may be coupled to the map data collector using a wired or wireless network connection. For example, map data collector 62 may use an internet connection made available by a smart phone, cellular phone, or other cellular enabled device such as a tablet or laptop computer coupled to vehicle interface 34. Map data collector 60 may use the coupled device's cellular, Wireless Local Access Network connection (WLAN also known as “Wi-Fi”), or other computer network connection to obtain map information from remote computers.

Map data may include graphical representations for display to user 36, perhaps on user interface 37, or computer machine readable representations encoded for integration, storage, and analysis for informing decision making by processor 46 or any other module within or connected to vehicle controller 34. As with the vehicle data collector 57, location data collector 60 may be implemented to sample or read location data values at a slower rate that is greater than every second, or greater than every 10 seconds, or at a faster rate generating a larger quantity of data such as greater than a thousand times a second, or greater than ten thousand times a second to name just a few examples. In another example, map data may be considered relatively static and may only be updated daily, weekly, monthly, or even less often. Data compression may also be useful as well to keep the quantity of map data from overwhelming the capacity of data store 50.

The collected map data may include data representing nodes, locations, or destinations as well as paths with corresponding path locations. The paths and nodes may correspond to existing physical locations such as streets, roads or highway intersections, buildings, landmarks, points of interest, restaurants, entertainment venues, homes, businesses, government facilities, and the like. Nodes and paths may also include user defined nodes or user defined data associated with existing nodes indicating additional details or places of interest. For example, a user may use a web browser interacting with a remote computer over a computer network such as the internet to define particular locations as being “home”, or “school”, or “office” and the like. These locations may be stored by the remote computer and provided to map data collector 62 over a wireless or wired network connection to aid in the disclosed calculations. Various graphical indicators may also be displayed in a graphical user interface on user interface 37 corresponding to the nodes (locations) and paths in the map data to aid user 36 in making choices with respect to routes and destinations. User interface 37 may also be configured to accept user input defining nodes, paths, or additional information about a node or path provided from a remote computer as well. This additional information, provided using user interface 37, a remote computer as disclosed above, or by another means may replace or be added to map data received from a remote source to provide aid in the prediction of resource consumption.

The additional data about nodes or paths (whether provided by the user or by another system) may include data such as elevation, grade, type of road surface, number of lanes, direction of travel, the existence and arrangement of traffic lights or other signals, a direction of travel permitted along the path, and whether traffic flow reverses along a given path or through a particular node at one time of day with respect to a second time of day (e.g. traffic flows west-bound during the mid-day and evening hours to move traffic out of town, and east-bound in the opposite direction in the morning to move traffic into town). Map data may also include information about when particular traffic lights flash yellow in the direction of one path and flash red in the direction of the intersecting path during off peak-hours switching to operate in a four-way red-yellow-green pattern at other times. Also included may be data regarding whether a traffic signals are triggered by the presence of vehicle traffic using a vehicle sensor triggered by vehicle proximity or weight, or are operated on a timer configured to control and coordinate a series of traffic signals to change signals in a sequence or pattern. Additional data may also include frequently traveled routes, or user selected preprogrammed routes. Nodes and paths may also include cost information such as whether a toll is collected at a particular node or collected after traversing a particular path.

Some or all of the map data collected by map data collector 62, as well as other map related data used by controller 34 may be obtained from a Geographic Information System (GIS) provider such as a government, a cartographer or company specializing in cartography, or from an internet-based service through a web browser, web service, Application Programming Interface (API), or other similar source. Examples of a remote web-based or API approach include map data provided by Google, Inc., based in Mountain View, Calif. and include Google Earth or Google Maps. These APIs and services currently include Google Places, Google Street View, and the Google Maps API for Business. Other examples of commercially available mapping services or software are provided by the Microsoft Corporation based in Redmond, Wash., and include software and web services such as the MapPoint® map software and maps or map data provided by the Bing® search engine, or map data provided using the Microsoft® Bing® Maps Platforms APIs.

Topographical data related to possible routes of travel is collected and stored in data store 50 by a topographical data collector 64. Topographical data is used by processor 46 to model changes in resource consumption based on significant variations in elevation along a route. Topographical data may be used in relation to map, vehicle, weather, and other data in data store 50 as well. For example, an electric vehicle will typically expend more energy driving up a long incline but may then reclaim some or all of that energy using regenerative braking on a down slope.

In one example, a topographical data collector 64 is connected to one or more sensors such as an altimeter or similar device operable to detect small changes in elevation. Such a device may be part of the original equipment provided by the manufacturer of vehicle 21, retrofitted later, or integrated into another device such as a portable altimeter or coupled to vehicle controller 34 by a wireless or wired connection. This type of data has the advantage of providing processor 46 with data that correlates to main battery, fuel, or other energy usage over a particular route or route segment that can correspond to nodes and paths collected by the map data collector 62. The altimeter data may be sampled like the location and map data previously mentioned at either a high rate (e.g. tens, hundreds or thousands of times a second, or more) for a more accurate representation of altitude changes, or at a lower rate (e.g. every second, every ten seconds, or even less often) to save space in data store 50. In another embodiment, the altimeter data is sampled as previously mentioned, but data is not saved to data store 50 unless the change in elevation since the last sample was stored is greater than a predetermined threshold, for example, greater than 10 feet, greater than 50 ft., or greater than 100 feet or more.

One example of topographical data collector 64 retrieves topographical data for a given route as the road is traversed. Another example of topographical data collector 64 retrieve an initial set of topographical data from an external or remote data source such as a remote computer accessible via a wired or wireless computer network connection. Topographical data collector 64 may retrieve relevant topography data to preload the data store 50 with topographical information corresponding to the route chosen or the general area surrounding the chosen route or destination. In another example, topographical data collector 64 preloads existing data from a remote source via a computer network to make initial calculations and then senses changes in altitude using an altitude sensing device as the vehicle proceeds along the route thereby updating the preloaded data for increased accuracy. In yet another example, topographical data collector 64 acquires elevation data from a mobile device such as a cell phone, smart phone, Personal Digital Assistant (PDA), tablet computer, or laptop computer connecting to a remote computer using a wired or wireless network to collect and store altitudes at particular locations, or along paths between locations.

The topographical data collected may also include or consist of changes in altitude at one location relative to one or more other locations. The topographical data retrieved from a remote source may be included with map information retrieved using map data collector 62. Topographical data may also be stored and retrieved separately from map data retrieved or stored in data store 50. However, map data may be used by some embodiments of topographical data collector 64 to query a remote systems (or data store 50) for specific topographical information to obtain data related to a route, a number of potential routes, or a geographical area including a route or a number of potential routes. These devices could either be connected to topographical data collector 64 or serve as the data collector themselves and be directly connected to data store 50.

Vehicle controller 34 can also collect weather data using a weather data collector 70. As with vehicle, location, and map data discussed above, weather data can be stored in data store 50 for analysis by processor 46 to model changes in the rate of consumption of vehicle resources caused by weather related phenomena. Pertinent weather data may include wind speed and direction, temperature, visibility, cloud cover, sunrise, sunset, and dew point. Whether data may also include precipitation information such as type of precipitation, and the amount of precipitation deposited over a predetermined period of time such as per minute, per hour, per day, and the like.

In one example, weather data collector 70 accesses weather data from one or more remote computer systems providing weather data from databases accessible through one or more wired or wireless networks such as the Internet. The wired or wireless network connection may be supplied by a mobile device such as a smart phone, laptop computer, and others as discussed above. Another example of weather data collector 70 supplements weather data accessed from a remote database with sensor readings taken from vehicle sensors as the vehicle traverses a selected route. Examples of types of data that may be collected by vehicle sensors include, but are not limited to, temperature, air pressure, visibility, and humidity.

Sampling rates of the various sensors collecting weather data may vary widely. As with previously discussed data collectors, sampling may occur at widely varying predetermined intervals such as hundreds or thousands of times a second or every second, every 5 seconds, or more. Any suitable sampling rate is envisioned and as noted above with vehicle, location, map, and topographical data collectors, the sampling rate may vary significantly and is not limited to a specific range. Similar to previous data collectors discussed, some examples of weather data collector 70 may optimize storage space in data store 50 by writing weather data to data store 50 when one or more of the values representing a particular atmospheric condition changes with respect to one or more recent samplings or readings, or changes with respect to a predetermined baseline value. In another example, weather data collector 70 may also economize storage space in data store 50 by accessing weather data from a remote database and maintaining it in temporary storage within data store 50 or a memory in controller 34 while resource predictions are calculated. In this example, once resource predictions are made and the calculations are completed, weather data may be deleted and retrieved again at a later time after a predetermined interval has passed (e.g. 30 or 60 minutes).

A traffic data collector 73 can collect traffic and road condition data and write it to data store 50 enabling processor 46 to make resource predictions based on traffic patterns and road conditions. One embodiment of traffic data collector 73 acquires traffic related information for the chosen route from a remote database accessible through a computer network such as the internet and saves traffic data to data store 50 for analysis by processor 46. Traffic and road conditions may include the existence of temporary obstructions to the flow of traffic such as construction zones, utility work, lane restrictions, traffic accidents, emergencies, and the like. It may also include traffic flow rates where available indicating the rate at which traffic is traveling over a given segment of one or more routes or potential travel routes. As with other data collectors mentioned above such as topographical and whether data collectors, traffic data collector 73 may access location data and map data, and possibly other data as well, from data store 50 to query for traffic data specific to nodes or locations, and paths or segments along a proposed route.

In another example, traffic data collector 73 reads positional data from data store 50 as the route is traversed and uses the positional information to calculate path, segment, or route timing information which can be stored in data store 50. In this way, route specific data can be created indicating areas where the average speed may change, or where traffic frequently stops and for how long. By repeatedly traversing substantially the same routes, traffic data collector 73 can develop data regarding traffic flow, number of stops, length of stops, average speed, and overall resources required for a given path, route segment, or route. In another example, traffic data collector 73 combines accessing traffic flow patterns from a remote database with data collected over time. In yet another example, the traffic data collector 73 is installed in emergency vehicles and is configured to communicate with automated traffic management systems to obtain additional data about, for example, traffic signals that can be controlled by vehicle controller 34 to modify traffic flows along a proposed route or route segment.

Analytics agent 53 as shown in FIG. 2 analyzes historical data to calculate the accuracy of the predictions made by processor 46. In one example, analytics agent 53 analyzes the results of past predictions searching for anomalies in predictions on particular routes, or route segments where the results are predictably incorrect for particular combinations of traffic, weather, vehicle, and topography variables. Analytics agent 53 can also calculate and write to data store 50 a set of modifiers that can be applied by processor 46 to future predictions to reduce or eliminate the difference between the predicted results and the actual results. In another example, analytics agent 53 increases the accuracy of resource prediction calculations performed by processor 46 by connecting to a remote server, and uploading some or all of the data used by processor 46 to make resource predictions. This data can include values representing predicted resource consumption and actual resource consumption for a particular route, route segment, destination, or intermediate node or location. The data may include vehicle, location, map, topographical, and whether data, and any other data processed by processor 46. The remote server may then process the data received and using it to develop or change the algorithms used by processor 46 to change its functionality, preferably to reduce or eliminate differences between actual results for a given route and calculated predictions made by processor 46. In one example, the internal algorithms executed by processor 46 may be changed using software updates such as a firmware update and the like. Analytics agent 53 may then download the upgraded software and install it in processor 46.

Processing of vehicle, location, map, topography, weather, traffic, and any other data used in predicting resource usage for vehicle 21 can be executed by processor 46. Using algorithms like those disclosed, processor 46 can analyze complex relationships between the current and future resource needs of the various vehicle systems to determine a likelihood of reaching a selected destination before available resources are fully expended (e.g. vehicle 21 runs out of fuel or discharges it's primary battery). Processor 46 may execute these algorithms more than several hundred, or several thousand times a second, perhaps more than several million times a second. Similarly, processor 46 may be programmed or controlled by an external controller to execute the disclosed algorithms at larger intervals such as intervals greater than every half second, greater than every five seconds, or greater than every minute to name a few non-limiting examples. Processor 46 may execute resource prediction more often for more accurate predictions, or less often to conserve processing resources such as power consumed in operating the processor or storage space in data store 50.

Considering further implementation specifics, the resource allocation system and method can operate as software executing on processor 46 which may include one or more physical or virtual processors or Central Processing Units (CPUs) and one or more types of memory. Each memory can include a removable memory device. Each processor may be comprised of one or more components configured as a single unit such as arithmetic units, controllers, and the like. Alternatively, when of a multi-component form, a processor may have one or more components located remotely relative to the others. One or more components of each processor may be of the electronic variety defining digital circuitry, analog circuitry, or both. In one embodiment, each processor is of a conventional, integrated circuit microprocessor arrangement, such as one or more PENTIUM, i3, i5 or i7 processors supplied by INTEL Corporation, Santa Clara, Calif. USA. In another example, the processor may be a programmable microcontroller such as the Cortex-M4F, Cortex-M3, or Cortex-M0 commercially available from STMicroelectronics of Geneva, Switzerland. Any suitable circuit capable of executing algorithms for predicting resource consumption and/or the likelihood of arriving at a selected destination may be used.

Each memory, whether part of processor 46, data store 50, or found elsewhere in controller 34 may be any suitable form of a computer-readable storage device. Each memory may include one or more types of solid-state electronic memory, magnetic memory, or optical memory, just to name a few. By way of non-limiting example, each memory may include solid-state electronic Random Access Memory (RAM), Sequentially Accessible Memory (SAM) (such as the First-In, First-Out (FIFO) variety or the Last-In-First-Out (LIFO) variety), Programmable Read Only Memory (PROM), Electronically Programmable Read Only Memory (EPROM), or Electrically Erasable Programmable Read Only Memory (EEPROM); an optical disc memory (such as a DVD or CD ROM); a magnetically encoded hard disc, floppy disc, tape, or cartridge media; or a combination of any of these memory types. Also, each memory may be volatile, nonvolatile, or a hybrid combination of volatile and nonvolatile varieties.

Processor 46 may be embodied as a “computer” in the generic sense and may be a single, physical, computing device such as a desktop computer, a laptop computer, microcontroller mounted to a Printed Circuit Board (PCB) with other supporting circuits, or may be composed of multiple devices of the same type such as a group of processors or computers operating as one device in a networked cluster, or a heterogeneous combination of different computing devices also linked together by a network and operating as one computer. Thus processor 46 may be composed of one or more physical computing devices having one or more physical processors or “processing cores” and memory as described above. Processor 46 may also be enclosed within a single housing or enclosure, or if so constructed, its component parts may be organized within a plurality of enclosures housing separate component parts or groups of parts working together to comprise processor 46.

Processor 46 can be coupled to a display for displaying user interface 37, for example, controller 34 may include an integrated display or be coupled to a display device located in a separate housing in another part of vehicle 21. Likewise, displays may be of the same type, or a heterogeneous combination of different visual devices. Although not shown, user interface 37 may also include or be coupled with one or more operator input devices such as a keyboard, mouse, capacitive, inductive, pressure sensitive, or any other sort of touch screen, laser or infrared pointing device, or gyroscopic pointing device to name just a few representative examples. Controller 34 may also include ports for connecting one or more other output devices such as data transmission devices like network adapters or diagnostic devices, other computers, printers, plotters, and the like. As such, various display, input and output device arrangements are possible.

The data and operating logic of controller 34, processor 46, and the other elements shown in FIG. 2 can be embodied in signals transmitted over a network, in programming instructions, dedicated hardware, or a combination of these. Thus communications between elements of controller 34 or with remote computers as discussed above can be achieved by various means such as a wireless or wired Local Area Network (LAN), Municipal Area Network (MAN), Wide Area Network (WAN), such as the Internet, a combination of these, or any other suitable computer network.

External data sources, some of which are described above, may also be connected to processor 46 via data access devices connected to these same communications links, or by data access devices providing data by other means such as via nonvolatile storage devices such as DVD or CD-ROM, flash memory devices, and the like. It shall be appreciated that in alternate forms a user may submit requests for range prediction, input relevant data, and view reports generated by the system as well as other relevant vehicle information on computing devices such as a user interface 37, PDAs, Blackberries, iPhones, iPads, smart phones or tablet computers, to name just a few illustrative examples.

FIG. 3 illustrates example actions that may be taken by processor 46 in calculating the probability of reaching a selected destination using the resources available to vehicle 21. An initialization action 80 may be executed which can include removing remnants of previous probability calculations, performing diagnostic self-evaluations, and determining if relevant data sources and/or sufficient data storage is available.

Driver specific parameters may also be loaded (83) which may be applied to the upcoming calculations. Driver specific parameters include parameters selected and maintained for individual drivers such as the driver's aggressiveness, the driver's preferred interior temperature, whether the driver prefers listening to the radio, MP3 player, or other entertainment devices, whether and to what extent the driver prefers to have the seats warmed, and other similar preferences. Driver specific parameters may also include the number of alternate routes controller 34 should calculate resource predictions for using a selected final destination. For example, user interface 37 may be used to request a prediction of the resources likely to be consumed traveling two, three, five, or more alternate routes to a given destination. In another example, driver specific parameters may include a route preference such as a preference for taking a more scenic route, a desire to avoid a particular neighborhood, a desire to avoid or traverse a particular section of interstate, or an explicit requirement to include a particular node or location or series of locations in the route.

Controller 34 can also read vehicle state information (85) from one or more of the systems for devices shown in in FIG. 1 and discussed above. Vehicle state information can include any number of variables representing the current state of the operating vehicle such as current flow from the main battery, tire pressure, engine temperature, fuel remaining, whether the seat heaters are activated and to what extent, how many occupants are in the vehicle, vehicle speed, and what gear the transmission is in to name just a few nonlimiting examples. Any number of parameters representing current vehicle state may be part of vehicle state information (85), including, but not limited to, those parameters collected by vehicle data collector 57.

Controller 34 can also read available weather data from data store 50 and generate a weather model (88). The resulting weather model 107 can maintain values representing the usage of the vehicle's energy resources (e.g. main battery, fossil fuel, fuel cells, super capacitor, and the like) as a function of weather, location, and time. This data may be collected from any available source including weather data collector 70. One embodiment of generating a weather model (88) may include segmenting the route, predicting weather related events likely to occur for each particular segment during the course of the trip, and using this information to calculate resource consumption resulting from these weather events. For example, weather data retrieved by weather data collector 70 may indicate clear and dry conditions for all segments of the route except the last eight which include a 50 percent chance of rain. Weather model 107 will therefore indicate a 50 percent chance of increased battery load due to equipment activated because of rain and poor visibility such as windshield wipers, head lights, running lights, fog lamps, climate control to adjust cabin temperature and humidity, or collision avoidance or range finding systems if available.

In another example, if the weather at the beginning of the trip involved steady rain, and the forecast stated a 50 percent chance of rain over the last eight segments of the route, generating a weather model 88 might result in a weather model 107 including a 50 percent chance of reduced battery drain over the last eight segments due to the deactivation of systems likely to be operated during periods of rain and poor visibility such as those mentioned above.

In another example, if weather data collector 70 indicated a 46 percent chance that three segments of the route will have snow-covered icy roads, then generating a weather model (88) might result in a weather model 107 having three segments with a 46 percent chance of increased resource consumption because of reduced surface friction, increased rolling resistance, and increased use of climate control and defrosting systems. Numerous variations are envisioned depending on the types of weather data collected by weather data collector 70 and the types of resources vehicle 21 has available that may be affected such as a main battery, super capacitor, fuel cells, or a supply of fossil fuel to name a few. Other embodiments of weather model 107 are envisioned as well including models correlating points along each route segment or partial segment with specific predicted levels of battery energy, fossil fuel, or other resources remaining at each point as well as an indication of the accuracy of the prediction. The resulting weather model 107, whatever form it may take, can be saved to data store 50 to facilitate further probability calculations and later data analysis.

A traffic model 111 may be generated (90) and stored in data store 50 as well. Traffic model 111 can include values derived from data collected from any available source including traffic data collector 73, the values representing changes in resource usage in relation to traffic flow. In one example, the route may be divided into segments and resource consumption for each individual segment may be calculated based on current traffic patterns. If, for example, data collected by traffic data collector 73 indicates a 75 percent chance that one segment of one of the routes currently under consideration will be completely blocked for thirty-five minutes by excessive traffic before the vehicle can pass through the area, then the resulting traffic model 111 might indicate a 75 percent chance of increased fuel usage and a corresponding reduction in efficiency due to the extra fuel burned at a decreased rate of travel. On the other hand, if vehicle controller 34 were performing this predictive calculation while currently in a traffic jam, the traffic model 111 generated at 90 might indicate an increased likelihood of success due to more efficient use of resources over the remainder of the route.

Another example of traffic model generation 90 generates a resource consumption profile by segmenting the route according to traffic usage and then calculating a range of battery, fuel, or other resource usages related to past traffic patterns along with the probability and extent of resource usage for each segment. These values would be stored in data tables in traffic model 111 and saved to data store 50 after creation at 90 for later use and processing.

A map model 113 is generated (92) using various map data such as data collected by map data collector 62 as well as from other sources and saved to data store 50. In one example, map model 113 is generated to include one or more maps that may be used to correlate location data received from location data collector 60 with one or more possible locations of interest, past destinations, and potential new destinations. Map model 113 can be used to organize relevant nodes representing geographic locations, and connecting paths or path segments representing streets, roads, or other paths that may be traversed by the vehicle. Map model 113 may also include polygonal or other similar representations of regions to be traversed or avoided during a trip or trips. This polygonal or other representation of a region may be two-dimensional (e.g. an area), or three dimensional (e.g. a volume) indicating variations in height or altitude as well as relative location. Thus map model 113 may be used to maintain an electronic computational representation of the region the vehicle route passes through that may be useful for other calculations. Map model 113 may include rendered images of the area to be traveled that may be rendered by processor 46, or obtained from a remote server and stored in data store 50. These rendered images may be displayed before, during, and after the trip on user interface 37, or on another display such as on a display coupled to a remote server analyzing the results of a given set of data retrieved by analytics agent 53.

At 95, a topography model 116 can also be generated. Topography model 116 can be used to organize topography data from various sources including data collected by topographical data collector 64. One example of generating a topography model (95) includes segmenting the one or more chosen routes based on changes in grade. For example, a segment of the route may be generated for typography model 116 where the grade for that segment is 1 percent. In this example, a new segment is created when the grade changes by some predetermined differential such as by greater than a tenth of a percent, greater than a half percent, or by greater than a one percent. Therefore stretches of the selected route having changes in grade of less than the predetermined differential are calculated as if they had substantially no change in grade. In this example of topography model 116, longer segments can be calculated for flatter sections and hilly sections of the route can be broken into numerous shorter segments. Long steady climbs and descents may then also appear as large single segments where the path has substantially the same grade (positive or negative) throughout the segment. With the route modeled in terms of changes in grade, each segment of the route can be assigned resource parameters indicating the resource usage required to navigate each segment due to the typography of that segment.

In another example, a topography model 116 is generated at 95 by segmenting the route based on changes in altitude. In this example, a new segment is created when altitude changes by a predetermined differential such when the altitude changes by more than 5 feet, more than 15 feet, more than 25 feet, or more than 75 feet. This embodiment of topography model generation 95 essentially generates a topographical data map of elevational changes over the selected route in topography model 111 and assigns resource drain or usage parameters to each segment indicating the resources required to navigate a particular segment due to the change in altitude occurring within that segment.

Other techniques for segmenting the route according to topography are also envisioned as well to facilitate a detailed computational analysis of how much energy is required to traverse the route. Information stored in topography model 111 can include data indicating how much energy, if any, can be harvested from the vehicle's regenerative braking systems, if available. This includes a prediction regarding at what times or locations during the trip, if any, the vehicle's primary battery will become temporarily unable to take further charging due to overheating, temporary overcharging, and the like. For those portions of the trip where the battery is unavailable for charging, regenerative braking may not be relied on for supplying energy to extend the vehicle's range and this possibility can be factored into topography model 111. At any rate, topographical information used in calculating a result is represented in topography model 111 and saved in data store 50 for later processing.

A probability of successfully reaching the intended location can be calculated when some or all of driver specific parameters 100, vehicle state 103, weather model 107, traffic model 111, map model 113, and topography model 116 have been generated. For example, as illustrated in FIG. 3, the initialization (80), reading of driver specific parameters (83), reading of vehicle state (85), and the generation of weather, traffic, map, and topography models (88, 90, 92, and 95) may occur as a separate data update cycle or data update control loop operating repeatedly without intervention by the user, optionally even occurring when no particular probability calculations have been requested. This separate operational loop provides for the most recent data models 107, 111, 113, 116, 119, as well as the most recent vehicle state 103 and driver specified parameters 100 to be used in any probability calculations that may be initiated.

FIG. 3 is illustrative only in that updates occurring in this separate data update cycle may occur as shown in a particular sequence, or they may operate synchronously or asynchronously in parallel, or in any combination of sequentially or in parallel. For example, the reading of driver specific parameters 83 may be initiated at the same time as the reading of vehicle state 85, the generation of a weather model 88, the generation of a topography model 95, etc. No particular order is required, and it may be advantageous to execute one or more of these actions in parallel, for example in a multi-threaded environment on separate processing cores or other processing hardware in the same or separate integrated circuits. It may, for example, provide a better use of processor 46 to read driver specific parameters (83) once a second, while generating a new weather model (88) at a slower rate, perhaps every 10 minutes given that weather may tend to change more slowly than driver preferences. In another example, it may be advantageous to read the vehicle state (85) a thousand times a second, while generating a new traffic model only every 5 minutes as it may be more likely for the vehicle state to change substantially faster than the flow of traffic along the route ahead, or along other possible routes. These are but a few examples as there are numerous possible variations on the timing of actions taken involving acquiring and processing data stored in data store 50.

The probability of successfully reaching a final destination may be requested (120) resulting in a final result 119, preferably after data store 50 contains at least some of the data discussed above. Driver specific parameters 100 are processed at 123, as well as vehicle state information 103 at 125. Data from weather model 107 is processed at 127, traffic model 111 at 129, map model 113 at 132, and topography model 116 at 135 and a final result 119 is calculated at 137. Various types of processing are considered, as well as various alternatives related to timing of the actions shown in FIG. 3

In one example, calculating a final result 137 calculates whether the vehicle has sufficient resources to reach the one or more destinations (either selected by the user or by controller 34) by processing the probability of success with respect to route data modeled in weather model 107, traffic model 111, map model 113, and topography model 116. The current vehicle states 103 and driver specific parameters 100 may be used as a starting point for current calculations. In this example, the calculations may proceed by considering each segment of each model and calculating the probable gain or loss in remaining resources such as battery energy, fuel, etc., and logging reasons for those predicted gains and losses. The gains and losses can be organized according to the various vehicle systems and subsystems across the various data models thus allowing the probability of success for the entire trip to be calculated. In this type way, complexities may be broken down, analyzed, and resolved providing additional accuracy that simpler processing systems may not be able to offer.

For example, the user may have initiated the probability calculation from atop a mountain having a half charged battery seeking home as a final destination. Topography model 111 might indicate a net gain in charge over several segments of the trip and the reason attached to that result might be, for example, battery charging from regenerative braking resulting from steady, high speeds due to unobstructed, extended negative grades. Given the vehicle's regenerative charging abilities, this alone might be sufficient to yield a high probability of successfully reaching the final destination. However, when factoring in the traffic and weather models for these same segments with long downhill grades, it might be found that the road is covered with ice and the vehicle must travel much slower than normal. Because harvesting energy from the vehicle's regenerative charging abilities is no longer an option due to lower speeds, the result may be a low probability of success without stopping to recharge first.

In another example, a simple calculation of distance to the final destination during daylight hours may indicate that vehicle 21 has enough fuel or battery charge to reach the destination. However, when weather model 107 is processed at 127, it may indicate that for the first half of the journey, heavy rain is expected reducing fuel efficiency and requiring the operation of resource draining devices such as HVAC defroster, windshield wipers, and headlights. Processing of traffic model 111 at 129 may also indicate that for the first half of the journey, traffic is expected to be slow-moving because of the rain and time of day. Processing of map model 113 at 132 may also indicate that for the second half of the journey, refueling or recharging stations are unavailable, although they are plentiful throughout the first half of the trip. It may also show that the first half of the route includes some traffic lights which are not timed and therefore stop and go traffic can be expected. When topography model 116 is processed at 135, it may show that the first half of the route is substantially flat with only small changes in grade, and the second half includes several long uphill grades resulting in substantial changes in elevation.

In the final result calculation 137, for example, an initial calculation using driver specific parameters 100, and vehicle state 103 might indicate a high probability of successfully reaching the final destination, perhaps 95%, given that the vehicle has enough fuel and or battery charge to make the trip. The calculations of weather model 107 at 127 and traffic model 111 at 129 would reduce this probability because of reduced speeds and increased resource consumption per mile because of bad weather resulting in a probability of success of perhaps 50%. The topography model 116 processed at 135 would further reduce this probability of success to perhaps 1% because of the increased resource consumption required for long uphill grades. Map model 113 processed at 132 may increase this probability back to about 95% by noting in the final result that a high probability of reaching the final destination can be achieved if vehicle resources are replenished at a refueling or recharging station near the end of the first half of the trip. Several such stations may then be retrieved from map model 113, or map data available in data store 50 or remotely for inclusion in final result 119.

In some examples, all models may have the same route segment size, while in others, the models may have differing route segment sizes. In one example, the segment size is the entire route. In this example, the success or failure of reaching the final destination includes an average calculation of the individual probabilities calculated at 127, 129, 132, and 135 based on each specific type of input 100, 103, 107, 111, 113, and 116 (and any others). The overall probability of reaching the destination given the current vehicle state 103 and driver specific parameters 100 may then be weighted more heavily toward a particular data model such as weather model 107, topography model 116, and the like. These are but a few non-limiting examples of scenarios under which various positive or negative factors can be overcome be calculated by processor 46 and controller 34 in calculating the likelihood of vehicle 21 successfully arriving at the selected final destination.

It should be noted that like the actions taken to generate various models discussed above (e.g. 80, 83, 85, 88, 90, 92, and 95), the processing of vehicle state and driver parameters (125 and 123), as well as the final result calculations performed by processor 46 (e.g. 123, 125, 127, 129, 132, and 137) may be performed in any suitable order, and may be performed at any time with respect to one another. FIG. 3 illustrates a sequential flow, but such a flow should not be a limitation implied by the figure, only an illustration of one example of how the procedures may be executed in processor 46. In another example, all the actions taken in the final result calculations 123-137 may executed in parallel, or in multiple threads at substantially the same time within processor 46, or individually on one or more processing units or processing cores at substantially the same time within processor 46. In another example, processor 46 may include individual processing units for each type of data model (e.g. a processing unit for weather model 107, a second processing unit for traffic model 111, etc.), with each individual processing unit enclosed in the same housing or package as part of the same removable circuit, or with each processing unit in separate housings or packages on separate integrated circuits or circuit boards.

Like model calculations discussed above, it may be advantageous to process models from data store 50 at significantly varying rates. For example, it may be advantageous to process traffic model 111 (at 129) once every 5 minutes or more, while processing vehicle state 103 (at 125) a thousand times a second, or more, or perhaps ten thousand times a second or more. This arrangement may be likely for traffic patterns to vary far more slowly than the state of vehicle 21. Similarly, it may only be advantageous to process topography model 116 (at 135) at two or three intervals calculated by processor 46 like after about 33% and 66% of the route have been traversed given that topography model 116 may not include data that is likely to change very often. Any suitable timing of model processing or the calculation of final result 119 is envisioned.

Final result 119 may be displayed or otherwise indicated on user interface 37 for user 36. Controller 34 updates the user interface (140) with a final result 119 resulting in the probability being updated (143) and completion of the request for an update (120). Various embodiments of user interface 37 are envisioned. One embodiment of user interface 37 displays the probability of successfully reaching the desired destination by the route selected as a number on a visual display. Another embodiment of user interface 37 indicates multiple routes to the desired location, and the probability of successfully completing each route. This probability may be indicated using colors, symbols, shapes, graphs, and any other suitable indicia.

If the probability of reaching the destination is below a predetermined threshold for any of the routes, user interface 37 may read the final result 119 to determine if any reasons were indicated as to why final result 119 includes a low probability of success. These reasons may then be reformulated and presented to the user as a list of one or more options for decreasing the use of resources such as battery energy or fuel. The user may then select or deselect the options and the user interface may then adjust the chance of successfully reaching the destination. For example, the final result 119 may indicate a 20% probability of successfully reaching the destination for a given route with options including turning off the air conditioner, heater, stereo, rear window defroster, seat heaters, head lights, cabin lights, radar collision avoidance system, or rear seat entertainment center. Turning off some or all of these vehicle systems might then raise the probability of success to 85%. The user may accept the route with the modified options list, which can result in controller 34 activating or deactivating these and other vehicle features and accessories using vehicle control interface 41.

Another embodiment of user interface 37 offers the user options to turn off the heater, heat lights, stereo, etc., while displaying next to each item the probability of successfully reaching the destination if that vehicle feature were to be disabled for the remainder of the trip. This may require calculating the probability of success (FIG. 3 at 120) once as if each feature were enabled, and again as if corresponding features were disabled, thus providing an accurate comparison of the results the user can expect from making different selections. This embodiment may also flash a warning message during the trip if the disabled accessories is re-enabled.

Another example of user interface 37 allows the user 36 to use processor 46 to recalculate a range of probabilities of successfully completing the trip for a given route as a function of average speed. User interface 37 may display a curve, graph, or series of selectors showing speed vs. probability of success and allowing the user to select the combination of speed and probability suitable to the present situation. This speed may then be saved in vehicle controller 34 as an average speed and if vehicle 21 nears or exceeds this speed during the journey, user interface 37 can warn the user to reduce speed to save fuel or battery energy. A similar embodiment allows the user to calculate a range of probabilities for a given route as a function of frequency of abrupt acceleration or “aggressiveness.” The user selects a calculated probability from the list supplied and then if the user accelerates rapidly too often, user interface 37 may warn user 36 that resources are being consumed too rapidly to reach the desired destination.

In another example, user interface 37 displays a color-coded map of the route with colors corresponding to higher or lower resource consuming locations or “hotspots” as indicated by weather model 107, traffic model 111, map model 113, and topography model 116. The user can selectively view information from each model overlaid on the route individually or in aggregate. This view of the modeled data offers insights regarding areas along the route that are particularly taxing on vehicle resources or offers clues as to how the driver may be able to alter the route, time of day the route is traveled, or other variables to achieve a different result.

In yet another example, user interface 37 offers user 36 a display with resource replenishment options such as charging stations, fuel stations, and the like for those situations where the vehicle likely cannot complete the journey before charging the battery, refueling the vehicle, or both. User interface 37 may give directions, maps, or both to nearby charging stations as well as map, location, and contact information for mobile charging service vehicles currently operating in the area. User interface 37 may also indicate the approximate additional time added to the trip due to the need for additional fuel, battery energy, or other resources. It may also, for example, indicate how long vehicle 21 will need to charge at each location to fully recharge (or refuel) given that a fixed charging station may have a different charging capacity than a mobile one. However, this embodiment of user interface 37 also allows the user to specify a maximum charging time in cases where time is limited. User interface 37 respondents by initiating probability calculations for each battery charging service available and updates user interface 37 with a display indicating the probability of successfully completing the entire trip after charging the battery at each location for the available time entered by the user. These are several embodiments of user interface 37, but others are envisioned.

Vehicle controller 34 has the ability to refine and adapt its probability calculations over time by means of analytics agent 53. One embodiment of analytics agent 53 loads trip data from data store 50 for all previously recorded route segments the vehicle has calculated probabilities for and then actually traveled over and compares the calculated probability of particular events occurring against the actual occurrence of those events. These results can be used to gauge the strength or weakness of current prediction algorithms and data sources. Another embodiment of analytics agent 53 connects to a remote data service through a network connection such as the internet or other remote connection and uploads all recorded route segments the vehicle has traveled and made probability calculations for since the last time analytics agent 53 uploaded data. Analytics agent 53 then waits a period of time for a reply from the remote service and upon receiving it, downloads a response which includes a software upgrade that includes improved algorithms yielding more accurate probability calculations.

As historical data is developed, it might be learned that for selected vehicles and for selected routes, some of the algorithm variables have a greater weight or importance than others in terms of fuel usage or battery life and utilization of the charge on the battery. It is important to allow some design freedom in this regard for the algorithm. The option of making the algorithm programmable with an electronic interface enables refinements based on the most recent and most relevant data.

In another aspect, vehicle controller 34 may include a dynamic braking algorithm 150 that controls the friction and regenerative braking systems of vehicle 21 in conjunction with or separately from the vehicle resource management algorithms disclosed above. Some embodiments of vehicle controller 34 may include options allowing user 36 to separately and independently enable and disable the predictive calculations disclosed above and the dynamic braking functions.

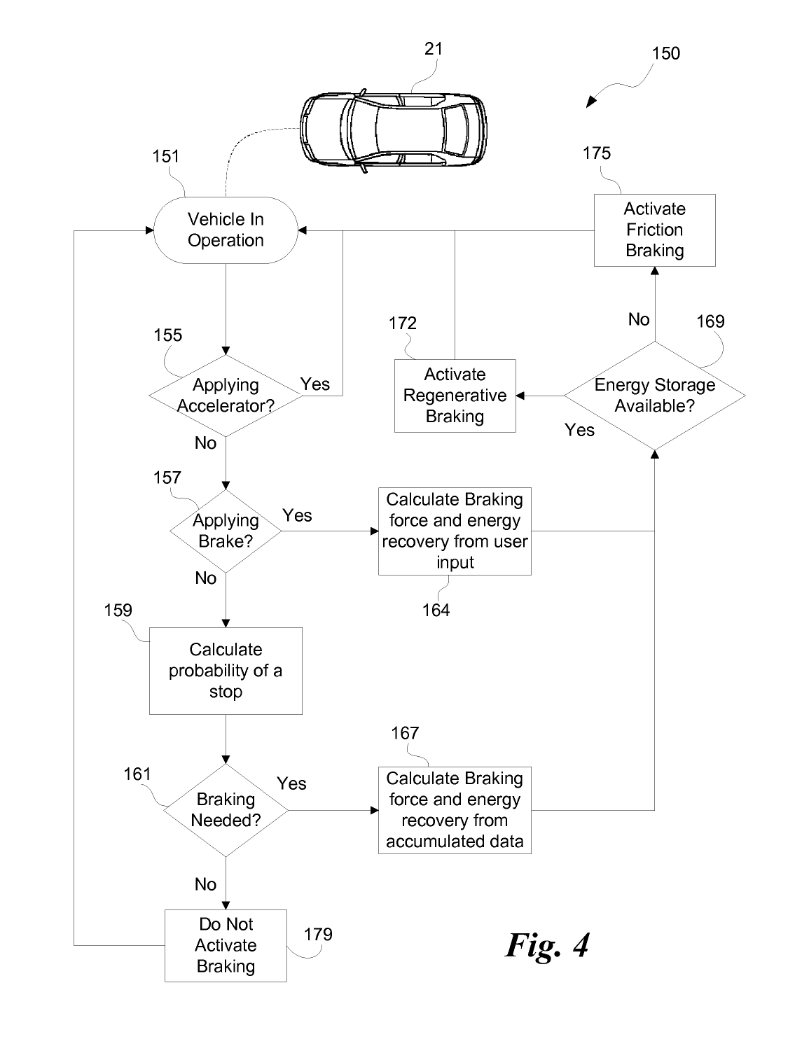

FIG. 4 illustrates at 150 one example of the actions vehicle controller 34 may take to manage the braking of vehicle 21. With the vehicle in operation (151), braking algorithm 150 determines whether or not the operator (for example, user 36) is applying the vehicle's accelerator (155). If so, braking is ignored and vehicle speed varies according to normal vehicle operation (151). If the operator is not applying the accelerator (155), the algorithm determines whether the operator is applying the brakes (157) by, for example, measuring or detecting application of pressure to a brake actuating mechanism such as a brake pedal or brake lever configured to engage the braking system.

If the operator is applying the brake to reduce the speed of vehicle 21, the algorithm calculates braking force and energy recovery from the user input (164). In one example, the braking force is a function of the distance the brake pedal or lever is deflected by the user from an un-actuated or resting position to an actuated position. In another example, the braking force is a function of the velocity of the brake pedal or lever as it is deflected at a particular rate from a resting or un-actuated position to a partial or fully actuated position over a period of time. In another example, both deflection and velocity are considered.

The amount of braking force is calculated, either by controller 34 or by vehicle 21 and the result is made available to controller 34, for example, via vehicle control interface 41. The approximate amount of energy the vehicle is expected to recover as electricity (if any) from regenerative braking is calculated based on the predicted amount of braking force. If the main battery or battery cells and charging equipment in vehicle 21 has the available capacity to accept and store this expected quantity of energy (169), controller 34 may activate regenerative braking to an extent proportional to the braking force calculated based on user input at 164. The result is a negative vehicle acceleration and possibly decreasing speed as energy is converted from vehicle kinetic energy through the wheels and vehicle drive train to electrical energy stored in a main battery or similar electrical storage device. Vehicle operation continues at 151 where braking and acceleration can be recalculated a new.

Energy storage is available in situations where vehicle 21's main battery is in a condition to receive energy. In some cases the battery may not be able to accept energy from further charging due to various conditions such as excessive battery heating due to recent charging or excessive momentary battery drain, or the main battery's inability to receive or maintain a charge because of age or deterioration, and the like. If other electrical energy storage devices are available such as, for example, super capacitors, the status and capacity of these devices can be determined as well at 169 allowing for them to possibly receive a charge as well.

If energy storage is not available (169), such as, for example, in vehicles not equipped with operating regenerative braking systems, or in vehicles where the main battery is unable to receive an additional charge, the algorithm activates a friction braking system to provide braking force approximately equal to the braking force calculated based on user input (164) as described above. The friction braking system applies friction to the wheels, usually indirectly through a disc or rotor coupled to the wheel and slowed by friction induced by pads pressed against the disc or rotor. This also results in negative acceleration and possibly a speed reduction. In this scenario, the vehicle operator explicitly applied the brakes (157) indicating some quantity of braking such as by deflecting a lever or pedal as described above. This causes dynamic braking algorithm 150 to activate the vehicle's friction braking system (175) after determining that no electrical energy storage capacity is available (169) causing the kinetic energy of vehicle 21 to be dissipated in some other way, such as through heat caused by friction. The resulting negative acceleration caused by applying the brakes at 157 is therefore approximately the same regardless of whether the regenerative braking system is activated (172) or the friction braking system is activated (175).

In some embodiments of algorithm 150, the system may execute the illustrated series of actions several hundred or thousands of times a second during braking, and may switch between regenerative and friction braking as vehicle 21 loses speed and it becomes possible to regeneratively brake or necessary to friction brake. In another example of algorithm 150, regenerative braking may be performed (172) so as to provide as much electricity as the storage batteries or charging system may be able to handle while also activating friction braking 175 to provide additional braking so that both regenerative and friction braking combined provide braking force about equal to the requested braking force calculated based on user input (164).

If, however, the driver does not apply the brake at 157, the algorithm may then determine the probability of a stop at 159. In one example, algorithm 150 compares vehicle 21's location to the known locations of stopping points along the vehicle's route which may be saved in map model 113, for example. Stopping points may be determined by examining map data collected from previous trips over the same route and recording points at which the vehicle came to a stop, or slowed to a speed below a predetermined “stopped” threshold along the same route in past trips. Areas where the vehicle came to a stop only once or twice during previous trips may be ignored as outliers resulting from anomalies in the traffic flow such as vehicle breakdowns, temporary obstructions in the road, variations in weather, and the like. The remaining points may be considered likely stopping points and can be compared with the current location of vehicle 21 as determined by GPS or map data in data store 50, or other similar location finding technology.

In another example of dynamic braking algorithm 150, stopping points may be determined from map data in data store 50 downloaded from a remote database like those described above which may indicate where stoplights, stop signs, heavy traffic, construction zones, and various other road obstructions are likely to appear or are permanently in place. In another example, dynamic braking algorithm 150 combines previous route history with remotely obtained map data to determine likely stopping points along the route. In another example, braking algorithm 150 may also consider weather, topography, and traffic data in determining the probability of a stop (159), as well as map data and previous driving history.

If the probability is equal to or greater than a predetermined braking threshold, and therefore the algorithm determines braking is needed (161), dynamic braking algorithm 150 calculates braking force and energy recovery resulting from the braking force from the accumulated data (167) in data store 50. In one example of calculating the braking force from accumulated data (167), dynamic braking algorithm 150 selects a predetermined light braking pressure to apply to the braking system, and then applies regenerative (172) or friction braking (175) accordingly, and recalculates beginning at 151. In another embodiment, dynamic braking algorithm 150 determines the degree of braking force to be applied by calculating negative deceleration that is inversely proportional to the distance to the next stopping point known. If algorithm 150 determines the next stopping point is close, dynamic braking algorithm 150 selects a significantly higher braking force to apply then if the distance between vehicle 21 and the next stopping point is larger. Algorithm 150 may also select the braking force based on an exponential, geometric, or logarithmic curve. For example, the algorithm may select a value of 10 representing the braking force selected when a stopping point is likely to be 100 feet away, versus selecting a value of 0.1 representing the braking force selected when a stopping point is likely to be 1000 feet away, a value which may result in almost no braking at all. In this example, one hundredth the braking force is applied for a stopping point ten times further away.

In yet another example, vehicle speed, the probability of a stop, and the distance to the likely stopping point may all be evaluated to calculate a value representing the selected braking force. In this example, exponential, logarithmic, or geometric curves may be used to adjust the selected braking force so that, for example, the braking force selected at a high rate of speed for a stopping point that is nearby will be proportionately much higher than the braking force selected for a lower speed or a stopping point likely to be further away. Driver specific parameters 100 may include values for setting whether algorithm 150 should optimize its selection of braking force based on recovering the maximum available vehicle kinetic energy (possibly resulting in a less comfortable ride), or providing a smooth driving experience for the operator and passengers, or some value selected along a gradient between these and possibly other extreme settings. For example, if optimized for maximum energy recovery, vehicle 21 may decelerate more sharply by applying regenerative braking to a greater extent upon lifting the accelerator rather than letting vehicle 21 coast with little or no braking as it might if optimized for a smoother ride.

The selected braking force can be used to calculate the energy that may be recovered (167) and algorithm 150 using processor 46 may execute the remaining actions of determining how much energy storage is available (169), and applying regenerative braking (172), friction braking (175), or both as discussed above, causing vehicle 21 to experience a negative acceleration and possibly reduction in speed. If the probability of a stop is below a predetermined braking threshold, and braking is determined to be unnecessary (161), no vehicle braking is activated leaving vehicle 21 to operate normally (151) gaining or losing speed without any intervention by the vehicle's braking system.

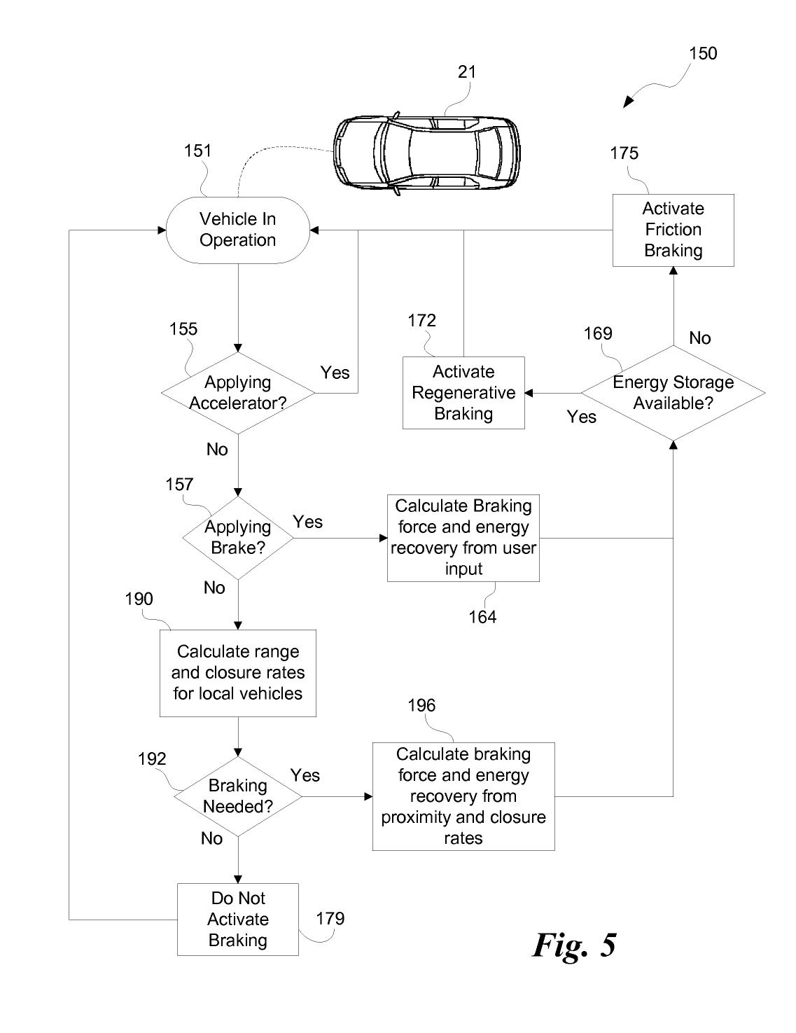

Another example of algorithm 150 is illustrated in FIG. 5 where dynamic braking algorithm 150 receives vehicle proximity data from proximity sensors (for example radar, laser, ultrasound, and the like) located on vehicle 21 which indicate how far away local vehicles are from vehicle 21 ahead, behind, to either side, or to any corner of the vehicle as well if so equipped. In this embodiment, dynamic braking algorithm 150 operates as discussed above, except the determination of whether braking is needed (192) is based on (or in addition to) calculating the range and closure rates with respect to local vehicles (190).

In one example, algorithm 150 selects a braking force that is inversely proportionate to the speed of vehicle 21, and the distance between another vehicle in front of or behind vehicle 21. A linear, exponential, logarithmic, geometric, or other formula may be used to select the braking force. Algorithm 150 may include in its calculations the distance between vehicle 21 and other nearby vehicles as well as the speed differential between vehicle 21 and nearby vehicles. For example, if vehicle 21 is traveling at a high rate of speed, such as on a limited access divided highway, where the nearest other vehicle is a thousand feet ahead, minimal if any braking may be selected by algorithm 50 when no accelerator input is provided by the user (155). However, if in this example vehicle 21 has another vehicle 10 feet ahead of it (moving at a similar high rate of speed), then not applying the brake (157) may result in perhaps 500 or 1000 times more braking force being selected, or even more, causing a substantial reduction in speed to create a more rapid separation from the nearby vehicle I had. On the other hand, if the other vehicle is 10 feet behind vehicle 21, perhaps only 5 times, 10 times, or 25 times the braking force may be selected when the operator lifts the accelerator (155) to avoid causing a rear end collision resulting from a substantial reduction in the speed of vehicle 21. As with previous values, these values are not restrictive but exemplary as many other values may be selected depending on the particular implementation of algorithm 150, the type of vehicle, and the values used to express the level of braking to be applied among other things.

In another example, calculating range and closure rates (190) takes into consideration vehicle attitude, that is the angle of inclination or descent, of vehicle 21 when it is coasting along with the resulting rate of acceleration or deceleration. In situations where vehicle 21 is climbing a hill, this embodiment of dynamic braking algorithm 150 can factor in the positive grade when calculating closure rates (190) as well as when calculating how much braking force to generate (196) given that the inclined road surface itself will provide assistance in stopping vehicle 21. Likewise, if vehicle 21 is accelerating because of a declining road surface, dynamic braking algorithm 150 will be more likely to apply greater braking pressure if a stop is near or a vehicle ahead is closing quickly because the speed and or acceleration of the vehicle may require a more substantial speed reduction over a shorter period of time to maintain control of the vehicle and avoid colliding with local vehicles in the immediate vicinity. Various other embodiments are envisioned as well these illustrative examples.

In yet another example, the closure rate of local vehicles near to vehicle 21 is calculated and evaluated in selected a braking force along with, or instead of, the distance to the local vehicles. For example, a vehicle ahead of vehicle 21 with a high closure rate may mean a larger braking force is selected by the algorithm. In another example, a vehicle behind vehicle 21 with a high closure rate may mean little if any braking force is preferred to avoid an accident.

The selected braking force can be used to calculate the energy that may be recovered (196), and the remainder of algorithm 150 can execute the actions of determining how much energy storage is available (169), and applying regenerative braking (172), friction braking (175), or both as discussed above, applying a negative acceleration to vehicle 21. If the proximity and closure rates of local vehicles is such that braking is not needed (192), no vehicle braking may be activated leaving vehicle 21 to coast gaining or losing speed without intervention from the vehicle's braking system.

While the invention has been illustrated and described in detail in the drawings and foregoing description, the same is to be considered as illustrative and not restrictive in character, it being understood that only the preferred embodiment has been shown and described and that all changes, equivalents, and modifications that come within the spirit of the inventions defined by following claims are desired to be protected. All publications, patents, and patent applications cited in this specification are herein incorporated by reference as if each individual publication, patent, or patent application were specifically and individually indicated to be incorporated by reference and set forth in its entirety herein.

What is claimed is:

1. A resource management system comprising:
a vehicle located at a current location having a vehicle drive system including energy storage means, the vehicle providing one or more operating parameter values indicating the operational state of the vehicle, the vehicle accepting one or more control values for controlling the consumption of one or more vehicle resources;
a user interface configured to accept input from a user representing a destination, and one or more trip variables corresponding to the rate of consumption of one or more vehicle resources consumed by the vehicle in operating the vehicle to reach the destination; and
a controller having a processor, the controller responsive to the vehicle and the user interface and accepting the operating parameter values, the trip variables, and one or more external data values from one or more external data sources, the processor calculating one or more control values provided to the vehicle, and at least one success probability representing the probability of the vehicle successfully completing the intended route.

2. The resource management system of claim 1, wherein the processor calculates the one or more control values by calculating a route between the current location and the destination, dividing the route into at least two segments, calculating at least two corresponding segment probabilities indicating the probability of successfully traveling through the corresponding at least two segments, and computing the at least one success probability based on the at least two corresponding segment probabilities.

3. The resource management system of claim 2, wherein the one or more external data values represent one or more environmental conditions, and wherein calculating the at least one success probability includes calculating changes in vehicle resources by calculating a predicted change in vehicle resources based on the one or more operating parameter values, the external data values, and the trip variables.

4. The resource management system of claim 3, wherein the external data values include map data values representing one or more locations, and one or more paths between locations, the locations and paths corresponding to geographic locations and travel paths.

5. The resource management system of claim 4, wherein the external data values include topography data values representing elevation changes between the current location and the destination.

6. The resource management system of claim 5, wherein the vehicle drive system includes an internal combustion engine.

7. The resource management system of claim 1 wherein the one or more external data values represent one or more environmental conditions.

8. The resource management system of claim 1 wherein the external data values include map data values representing one or more locations, and one or more paths between locations, the locations and paths corresponding to geographic locations and travel paths.

9. The resource management system of claim 1 wherein the external data values include topography data values representing elevation changes between the current location and the destination.

10. The resource management system of claim 1 wherein the vehicle drive system includes an internal combustion engine.

11. The resource management system of claim 1 wherein said energy storage means includes electrical storage means and/or chemical storage means and/or mechanical storage means.

12. A vehicle braking system comprising:
a vehicle located at a current location having a friction braking system and a vehicle drive system including energy storage means operating as part of a regenerative braking system, the vehicle providing one or more operating parameter values indicating the operational state of the vehicle; and
a controller having a processor, the controller responsive to the vehicle, the controller accepting the operating parameter values and one or more external data values from one or more external data sources, the processor calculating one or more braking control parameters for optimization of the regenerative braking system to maximize stored energy while safely operating the vehicle.

13. The vehicle braking system of claim 12, wherein the processor calculates the one or more braking control parameters using one or more external data values representing the location of predicted stopping points, the processor calculating one or more braking control parameters and applying a braking force which optimizes stored energy based on the distance to the next predicted stopping point.

14. The vehicle braking system of claim 13 further comprising one or more vehicle sensors responsive to one or more nearby vehicles, the controller responsive to the vehicle sensors, wherein the processor calculates one or more braking control parameters and applies a braking force which optimizes stored energy while maintaining a desired separation distance between the vehicle and at least one nearby vehicle.

15. The vehicle braking system of claim 13 wherein the processor calculates one or more braking control parameters and applies a braking force based on closing speed differential representing the difference between a current vehicle speed and a speed of at least one nearby vehicle to optimize energy storage while safely operating the vehicle.

16. The vehicle braking system of claim 12, wherein the processor calculates the one or more braking control parameters using one or more external data values representing the location of predicted stopping points, the processor calculating one or more braking control parameters and applying a braking force which optimizes stored energy based on the current speed of the vehicle.

17. The vehicle braking system of claim 16, further comprising one or more vehicle sensors responsive to one or more nearby vehicles, the controller responsive to the vehicle sensors, wherein the processor calculates one or more braking control parameters and applies a braking force which optimizes stored energy while maintaining a desired separation distance between the vehicle and at least one nearby vehicle.

18. The vehicle braking system of claim 16 wherein the processor calculates one or more braking control parameters and applies a braking force based on a closing speed differential representing the difference between a current vehicle speed and a speed of at least one nearby vehicle to optimize energy storage while safely operating the vehicle.

19. The vehicle braking system of claim 12, further comprising:
one or more vehicle sensors responsive to one or more nearby vehicles, the controller responsive to the vehicle sensors;
wherein the processor calculates one or more braking control parameters and applies a braking force which optimizes stored energy while maintaining a desired separation distance between the vehicle and at least one nearby vehicle.

20. The vehicle braking system of claim 19, wherein the processor calculates one or more braking control parameters and applies a braking force based on a closing speed differential representing the difference between a current vehicle speed and a speed of at least one nearby vehicle to optimize energy storage while safely operating the vehicle.

21. The vehicle braking system of claim 12 wherein said processor calculates one or more braking control parameters based on one or more external conditions such as temperature, wind and moisture for optimizing energy storage while safely operating the vehicle.

22. The vehicle braking system of claim 12 wherein said energy storage means includes electrical storage means and/or chemical storage means and/or mechanical storage means.

23. A vehicle power control system comprising:
a vehicle located at a current location having a vehicle drive system including an energy storage device as part of a regenerative braking system, the vehicle providing one or more operating parameter values indicating the operational state of the vehicle; and
a controller having a processor, the controller accepting the operating parameter values and one or more external data values from one or more external data sources, the processor being constructed and arranged for calculating one or more power control parameters for controlling the activation of the vehicle drive system for the purposes of predicting future demand and safely minimizing total energy expenditure.
